(19) United States
(12) Patent Application Publication
(10) Pub. No.: US 2008/0013898 A1
(43) Pub. Date: Jan. 17, 2008

(54) Multi-piece protective mold

(76) Inventor: Dennis Ray Wells, Richfield, MN (US)

Correspondence Address: MERCHANT & GOULD PC, P.O. BOX 2903, MINNEAPOLIS, MN, 55402-0903, US

(21) Appl. No.: 11/827,374

(22) Filed: Jul. 11, 2007

Related U.S. Application Data
(60) Provisional application No. 60/819,924, filed on Jul. 11, 2006.

(51) Int. Cl. G02B 6/255

(52) U.S. Cl. 385/96; 264/1.28

(57) ABSTRACT

Protecting a breakout assembly at a breakout location of a distribution cable includes forming two flexible shells from a polyurethane material having a durometer ranging from about 80 to about 95 Shore A. A through passage configured to receive a stripped region of the distribution cable extends from opposite ends of the flexible shells. To fuse the flexible shells, a user can arrange the shells on opposing press molds, arrange the breakout assembly within one of the flexible shells, and compress the shells together. In certain embodiments, the shells can be heated before compressing. Examples heating techniques include heating bands, ultra-sonic welding, and blowing heated air over the engagement surfaces.

### CROSS REFERENCE TO RELATED APPLICATIONS

This application claims priority from provisional application Ser. No. 60/819,924, filed Jul. 11, 2006, and which is incorporated herein by reference.

### TECHNICAL FIELD

The principles disclosed herein relate to fiber optic cable systems. More particularly, the present disclosure relates to fiber optic cable systems having main cables and branch cables.

### BACKGROUND

Passive optical networks are becoming prevalent in part because service providers want to deliver high bandwidth communication capabilities to customers. Passive optical networks are a desirable choice for delivering high-speed communication data because they may not employ active electronic devices, such as amplifiers and repeaters, between a central office and a subscriber termination. The absence of active electronic devices may decrease network complexity and/or cost and may increase network reliability.

FIG. 1 illustrates a network 100 deploying passive fiber optic lines. As shown in FIG. 1, the network 100 may include a central office 110 that connects a number of end subscribers 115 (also called end users 115 herein) in a network. The central office 110 may additionally connect to a larger network such as the Internet (not shown) and a public switched telephone network (PSTN). The network 100 may also include fiber distribution hubs (FDHs) 130 having one or more optical splitters (e.g., 1-to-8 splitters, 1-to-16 splitters, or 1-to-32 splitters) that generate a number of individual fibers that may lead to the premises of an end user 115. The various lines of the network can be aerial or housed within underground conduits (e.g., see conduit 105).

The portion of network 100 that is closest to central office 110 is generally referred to as the F1 region, where F1 is the “feeder fiber” from the central office. The F1 portion of the network may include a distribution cable having on the order of 12 to 48 fibers; however, alternative implementations may include fewer or more fibers. The portion of network 100 that includes an FDH 130 and a number of end users 115 may be referred to as an F2 portion of network 100. Splitters used in an FDH 130 may accept a feeder cable having a number of fibers and may split those incoming fibers into, for example, 216 to 432 individual distribution fibers that may be associated with a like number of end user locations.

Referring to FIG. 1, the network 100 includes a plurality of breakout locations 125 at which branch cables (e.g., drop cables, stub cables, etc.) are separated out from main cables (e.g., distribution cables). Breakout locations can also be referred to as tap locations or branch locations and branch cables can also be referred to as breakout cables. At a breakout location, fibers of the branch cables are typically spliced to selected fibers of the main cable. However, for certain applications, the interface between the fibers of the main cable and the fibers of the branch cables can be connectorized.

Stub cables are typically branch cables that are routed from breakout locations to intermediate access locations such as a pedestals, drop terminals or hubs. Intermediate access locations can provide connector interfaces located between breakout locations and subscriber locations. A drop cable is a cable that typically forms the last leg to a subscriber location. For example, drop cables are routed from intermediate access locations to subscriber locations. Drop cables can also be routed directly from breakout locations to subscriber locations hereby bypassing any intermediate access locations.

Branch cables can manually be separated out from a main cable in the field using field splices. Field splices are typically housed within sealed splice enclosures. Manual splicing in the field is time consuming and expensive.

As an alternative to manual splicing in the field, pre-terminated cable systems have been developed. Pre-terminated cable systems include factory integrated breakout locations manufactured at predetermined positions along the length of a main cable (e.g., see U.S. Pat. Nos. 4,961,623; 5,125,060; and 5,210,812). However, the installation of pre-terminated cables can be difficult. For example, for underground applications, pre-terminations can complicate passing pre-terminated cable through the underground conduit typically used to hold fiber optic cable (e.g., 1.25 inch inner diameter conduit). Similarly, for aerial applications, pre-terminations can complicate passing pre-terminated cable through aerial cable retention loops.

### SUMMARY

Certain aspects of the disclosure relate to mid-span breakout configurations for pre-terminated fiber optic distribution cables.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 shows a prior art passive fiber optic network;

FIG. 2 is a perspective view of a mid-span breakout assembly having features that are examples of inventive aspects in accordance with the principles of the present disclosure;

FIG. 3 is a cross sectional view of an example distribution cable;

FIG. 4 is a cross sectional view of an example tether;

FIG. 5 is a perspective view of an example retention block used at the mid-span breakout location of FIG. 2;

FIG. 6 shows an initial preparation of the distribution cable at the mid-span breakout location of FIG. 2;

FIG. 7 shows a first preparation step for a tether used at the mid-span breakout location of FIG. 2;

FIG. 8 is a subsequent preparation step of the tether of FIG. 7;

FIG. 9 is a perspective view of an example enclosure shell used to protect a mid-span breakout assembly;

FIG. 10 is a top view of the example enclosure shell of FIG. 9;

FIG. 11 is a side view of the example enclosure shell of FIG. 9;

FIG. 12 is an end view of the first end of the example enclosure shell of FIG. 9;

FIG. 13 is an end view of the second end of the example enclosure shell of FIG. 9;

FIG. 14 is a perspective view of the example enclosure shell of FIG. 9 retaining the breakout assembly of FIG. 2;

FIG. 15 is a top view of the enclosure shell and breakout assembly of FIG. 14;

FIG. 16 is a flow chart depicting an operation flow for a process by which two enclosure shells can be secured around a breakout assembly;

FIG. 17 is a perspective view of the enclosure shell of FIG. 9 aligned with an opposing enclosure shell;

FIG. 18 is a perspective view of the enclosure shell of FIG. 14 aligned with an opposing enclosure shell;

FIG. 19 is a schematic view of a heating band assembly configured to heat the engagement surfaces of an enclosure shell;

FIG. 20 is a partial, front perspective view of end pieces of a heating band assembly heating the ends of an enclosure shell;

FIG. 21 is a top view of the enclosure shells of FIG. 18 fused together to form an enclosure; and

FIG. 22 is a schematic view showing a distribution cable bent along a 90 degree curve at a maximum bend radius.

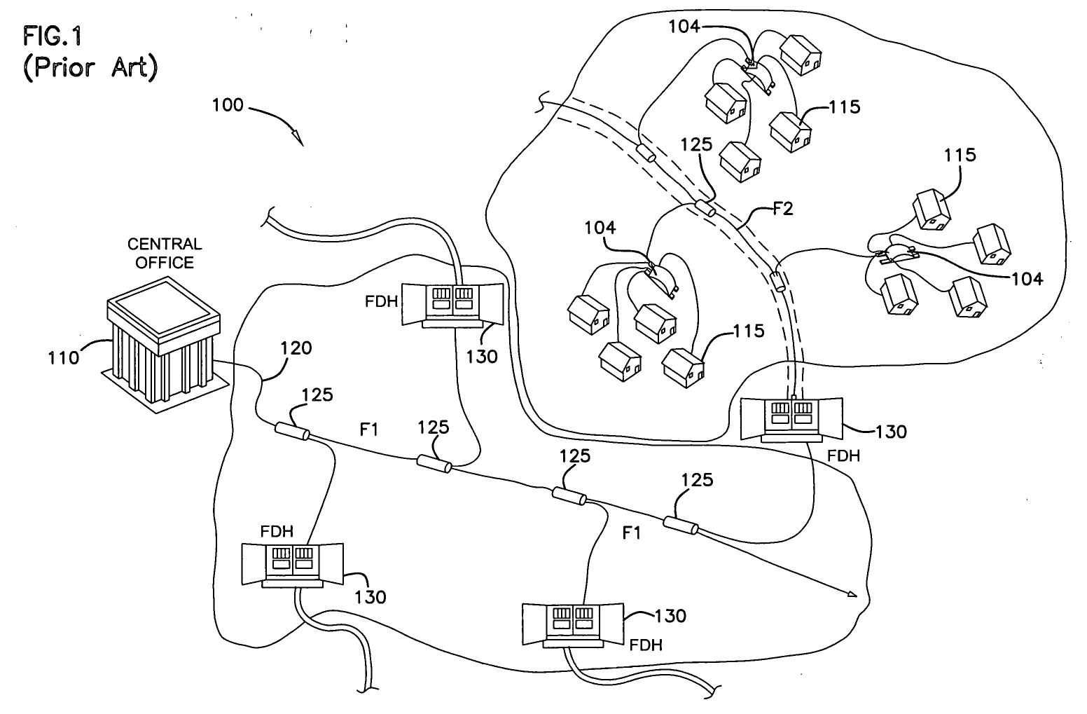

### DETAILED DESCRIPTION

The present disclosure relates to mid-span breakout assemblies provided on distribution cables. Each breakout assembly is provided at a breakout location to protect the optical coupling of a tether to the distribution cable.

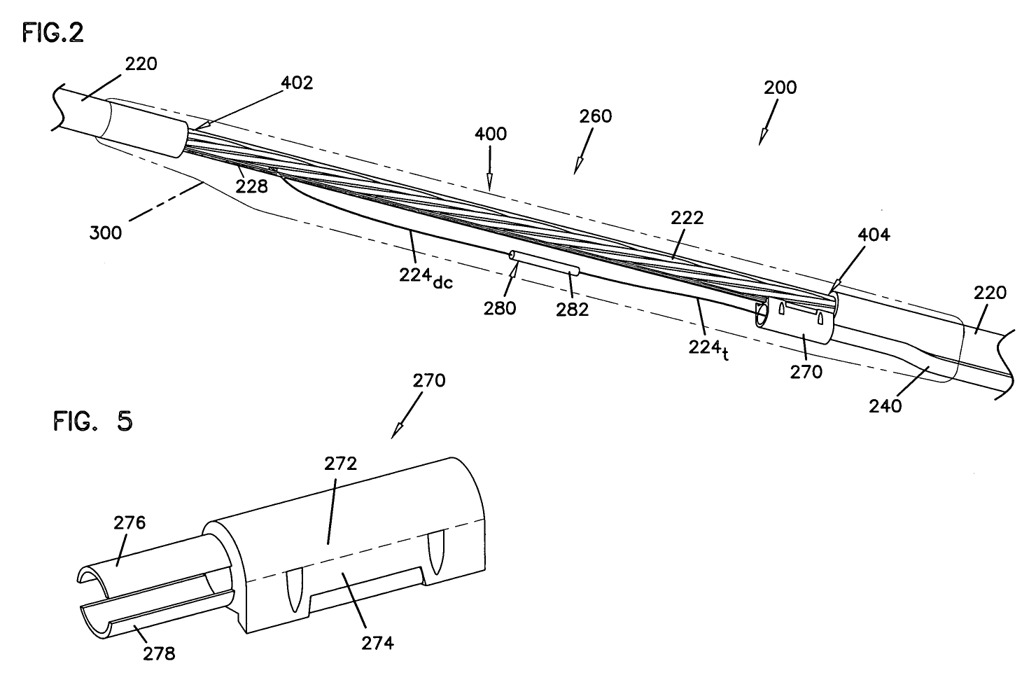

Referring now to FIGS. 2-4, a typical breakout location 260 is provided at an intermediate point along the length of a distribution cable 220 (FIG. 2). A typical distribution cable includes a relatively large number of fibers (e.g., 72, 144 or more fibers). The fibers are typically positioned within at least one buffer tube. In certain embodiments, the fibers are segregated into separate groups with each group contained within a separate buffer tube. The fibers within the one or more buffer tubes can include either ribbon fibers or loose fibers.

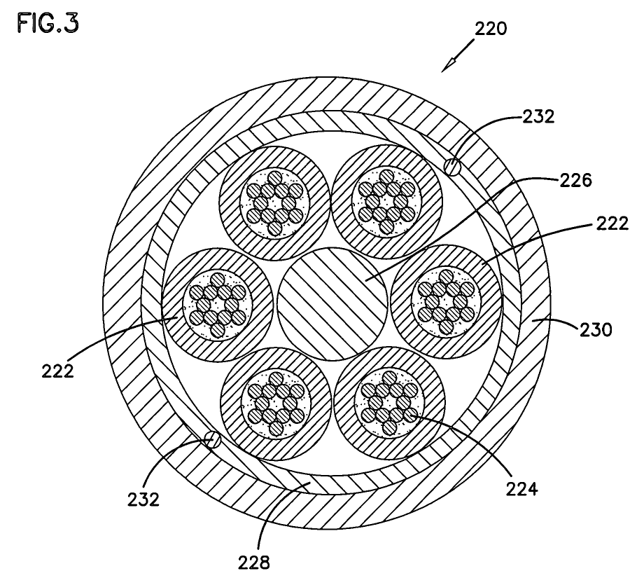

FIG. 3 shows an example distribution cable 220 including six separate buffer tubes 222 each containing twelve fibers 224_{dc}. The buffer tubes 222 may be gel filled. The distribution cable 220 also includes a central strength member 226 for reinforcing the cable 220, and an outer strength member/layer 228 such as aramid fiber/yarn (e.g., Kevlar®) for also reinforcing the cable. The distribution cable 220 further includes an outer jacket 230 that encloses the buffer tubes 222. Ripcords 232 can be provided for facilitating tearing away portions of the jacket 230 to access the fibers 224_{dc} within the jacket 230.

While distribution cables typically have a large number of fibers, the various aspects of the present disclosure are also applicable to distribution cables having fewer numbers of fibers (e.g., 2 or more fibers). For example, the distribution cable can include an outer jacket enclosing a single buffer tube and two strength members extending on opposite sides of the single buffer tube. An outer strength member, such as aramid fiber/yarn, can surround the single buffer tube within the jacket. The single buffer tube can enclose loose fibers or ribbon fibers.

A tether (e.g., a drop cable or a stub cable) 240 can branch out from the distribution cable 220 at a breakout location 260 (see FIG. 2). The outer jacket 230 of the distribution cable 220 is stripped away to provide access to the at least one buffer tube 222 at a stripped region 400 of the distribution cable 220 (see FIG. 2). At least one fiber 224ₜ of a tether 240 couples to a distribution cable fiber 224_{dc} extending from one or more of the exposed buffer tubes 222 (see FIG. 2). The tether fibers 224ₜ extend between first and second ends. The first ends of the tether fibers 224ₜ are preferably spliced to selected fibers 224_{dc} of the distribution cable 220 (e.g., typically less than twelve fibers) at an optical coupling location 280. The second ends of the tether fibers 224ₜ are configured to optically couple to a drop terminal or other type of telecommunications equipment (not shown) offset from the breakout location 260.

FIG. 4 illustrates a tether 240 configured to join to the distribution cable 220 at the breakout location 260. The tether 240 is depicted as having a flat cable configuration. The flat cable configuration includes a central buffer tube 242 containing a plurality of fibers 224ₜ (e.g., typically one to twelve loose or ribbonized fibers). Strength members 246 (e.g., flexible rods formed by glass fiber reinforced epoxy) are positioned on opposite sides of the central buffer tube 242. An outer jacket 250 surrounds the strength members 246 and the buffer tube 242. The outer jacket 250 includes an outer perimeter having an elongated transverse cross-sectional shape. An additional strength layer 248 (e.g., aramid fiber/yarn, such as Kevlar) can be positioned between the buffer tube 242 and the outer jacket 250. As shown at FIG. 4, the transverse cross-sectional shape includes oppositely positioned, generally parallel sides 252 interconnected by rounded ends 254. However, any suitable cable configuration can be utilized for both the distribution cable 220 and the tether 240.

Referring back to FIG. 2, FIG. 2 also illustrates a mid-span breakout assembly 200 having features that are examples of inventive aspects in accordance with the principles of the present disclosure. The breakout assembly 200 includes a sleeve 282 mounted over the optical coupling location 280. The breakout assembly 200 also includes an enclosure 300 protecting the spliced optical fibers 224_{dc}, 224ₜ and the exposed buffer tubes 222 of the distribution cable 220. In general, one end of the protective enclosure 300 extends over the outer jacket 230 of the distribution cable 220 adjacent a first end 402 of the stripped region 400 and the other end of the protective enclosure 300 extends over the outer jackets 230, 250 of the distribution cable 220 and the tether 240, respectively, adjacent a second end 404 of the stripped region 400.

When the tether 240 is secured to the distribution cable 220, the tether 240 should preferably be able to withstand a pullout force of at least one hundred pounds. To meet this pullout force requirement, the breakout assembly 200 also includes a retention block 270 (see FIG. 5) configured to strengthen the mechanical interface between the tether 240 and the distribution cable 220. Typically, the retention block 270 is enclosed within the protective enclosure 300. As shown at FIG. 5, the retention block 270 includes a base 274 and a cover 272 between which the fiber 224ₜ of the tether 240 extends. First and second protrusions 276, 278 extend from the cover 272 and base 274, respectively. In one embodiment, the retention block 270 has a polycarbonate construction. Further details regarding the retention block 270 can be found in U.S. provisional application Ser. No. 60/781,280, filed Mar. 9, 2006, and entitled “FIBER OPTIC CABLE BREAKOUT CONFIGURATION,” the disclosure of which is hereby incorporated by reference.

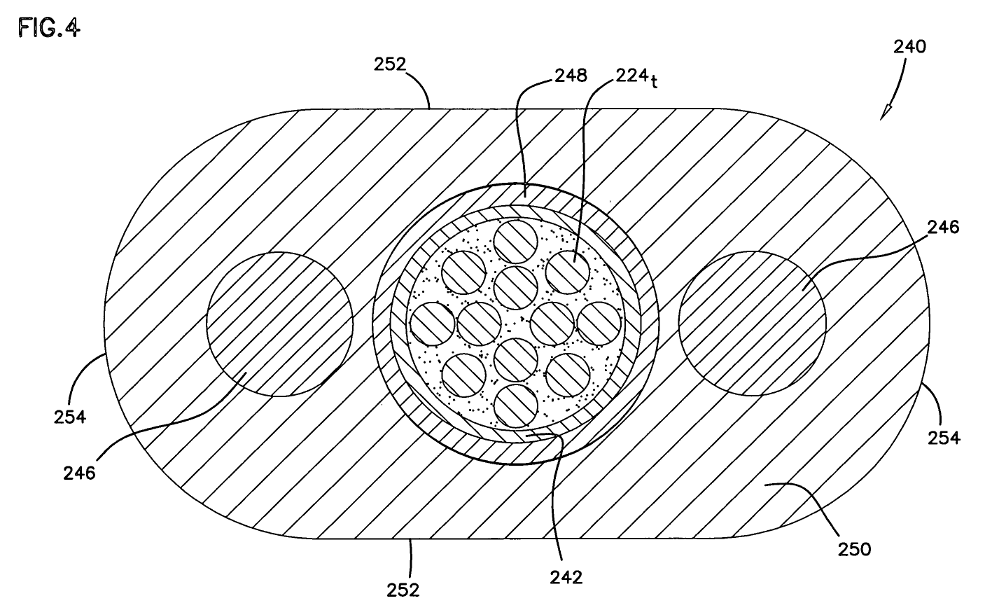

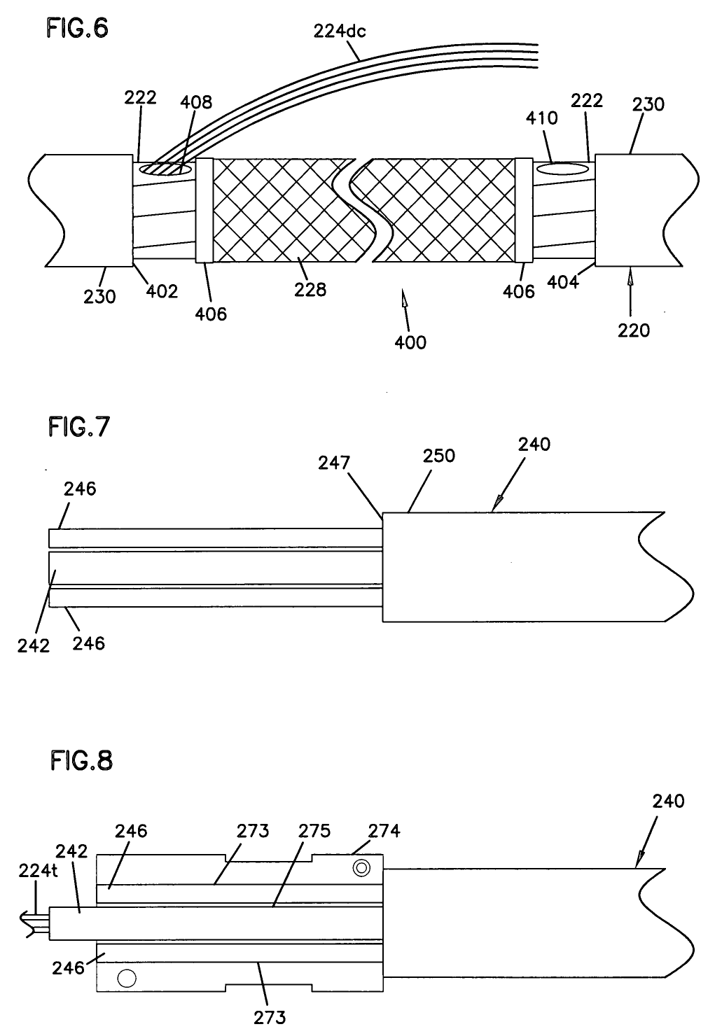

Referring now to FIGS. 6-8, to prepare the breakout location 260 on the distribution cable 220, a portion of the outer jacket 230 of the distribution cable 220 is first stripped away to provide the stripped region 400 having a first end 402 and a second end 404. In certain embodiments, portions of a cable netting can be removed adjacent the first and second ends 402, 404 so that the buffer tubes 222 are exposed (e.g., see FIG. 6). The outer strength member 228 can also be displaced (e.g., bunched at one side of the cable 220) adjacent the ends 402, 404 to facilitate access to the buffer tubes 222 (e.g., see FIG. 2). Tape 406 can be used to prevent the intermediate length of netting that remains at the mid-span breakout location 260 from unraveling (e.g., see FIG. 6).

One of the buffer tubes 222 is then selected and a first window 408 is cut into the buffer tube 222 adjacent the first end 402 of the stripped region 400 and a second window 410 is cut into the buffer tube 222 adjacent the second end 404 of the stripped region 400. The fibers 224_{dc} desired to be broken out are accessed and severed at the second window 410. After the fibers 224_{dc} have been severed, the fibers 224_{dc} are pulled from the buffer tube 222 through the first window 408 (see FIG. 6). With the distribution cable 220 is prepared as shown in FIG. 6, the fibers 224_{dc} are ready to be terminated to a prepared tether 240.

To prepare the tether 240 to be incorporated into the breakout assembly 200, a portion of the outer jacket 250 is stripped away to expose the central buffer tube 242 and the strength members 246 (see FIG. 7). As shown at FIG. 7, the central buffer tube 242 and the strength members 246 project outwardly beyond an end 247 of the outer jacket 250. The strength layer 248 has been removed from around the buffer tube 242. After removing the end portion of the outer jacket 250, the strength members 246 are trimmed as shown at FIG. 8, and an end portion of the central buffer tube 242 is removed to expose the fibers 224ₜ.

The tether 240 is then mounted to the base 274 of the retention block 270. For example, as shown at FIG. 8, the strength members 246 can be positioned within side grooves 273 of the base 274, and the central buffer tube 242 can be inserted within a central groove 275 of the base 274. As shown in FIG. 8, the central buffer tube 242 has a length that extends beyond a first end of the base 274, and the strength members 246 have lengths that terminate generally at the first end of the base 274.

To connect the tether fibers 224ₜ to the distribution cable fibers 224_{dc}, the sleeve 282 is first slid over the fibers 224ₜ of the tether and up against the retention block 270. In certain embodiments, the sleeve 282 can be slid up over the buffer tube 242 of the tether 240. With the sleeve 282 mounted on the tether 240, the fibers 224, of the tether are optically coupled (e.g., spliced) to the fibers 224_{dc} of the distribution cable 220. After the fiber coupling process is complete, the sleeve 282 can be slid over the coupling location 280 (e.g., see FIG. 2). The fibers are then tested to confirm that the fibers meet minimum insertion loss requirements. After verifying insertion loss, a protective enclosure 300 can be provided to enclose the breakout location 260.

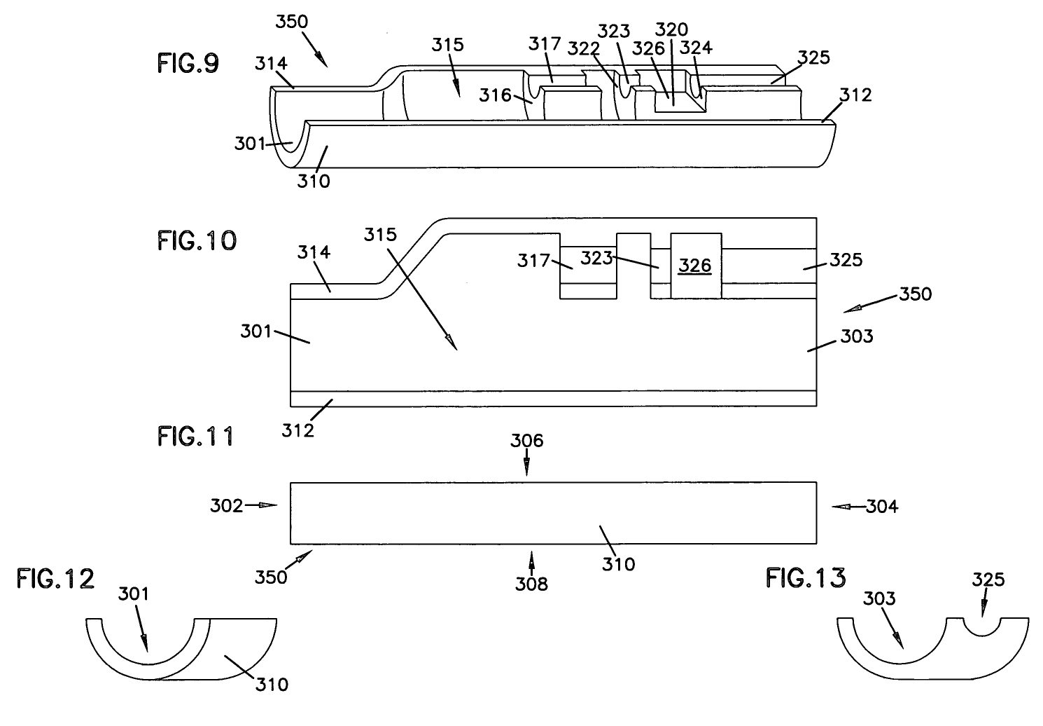

Referring now to FIGS. 9-13, the protective enclosure 300 can be formed from securing two half shells 350 together. In a preferred embodiment, the two half shells 350 are fused together by heating the shells 350 and pressing the heated shells 350 together. Example heating techniques include applying a heating band over the shells 350, blowing heated gas over the shells 350, and ultrasonic welding the shells 350. In other embodiments, however, the shells 350 can be secured together using adhesive or fasteners.

One example of a half shell 350 is shown in FIGS. 9-13. The half shell 350 has a body 310 extending from a first end 302 to a second end 304 (FIG. 11). The body 310 of the half shell 350 also has a first side 306 and a second side 308 (FIG. 11). In certain embodiments, the body 310 is formed from a flexible material. For example, in some embodiments, the body 310 has a durometer ranging from about 75 Shore A to about 95 Shore A. In a preferred embodiment, the body 310 has a durometer of about 85 Shore A. In one example embodiment, the body 310 is formed from polyurethane. In other embodiments, the body 310 can be formed from any suitable material.

The first side 306 of the body 310 forms a first side edge 312, which extends linearly from the first end 302 to the second end 304, and a second side edge 314, which curves outwardly from the first side edge 312 at an intermediate point between the first and second ends 302, 304. When two shells 350 are fused, the side edges 312, 314 of each shell 350 form an engagement surface. The second sides 308 of each shell 350 form a continuously curving surface around the distribution cable 220 at the breakout location 260 (e.g., see FIG. 2).

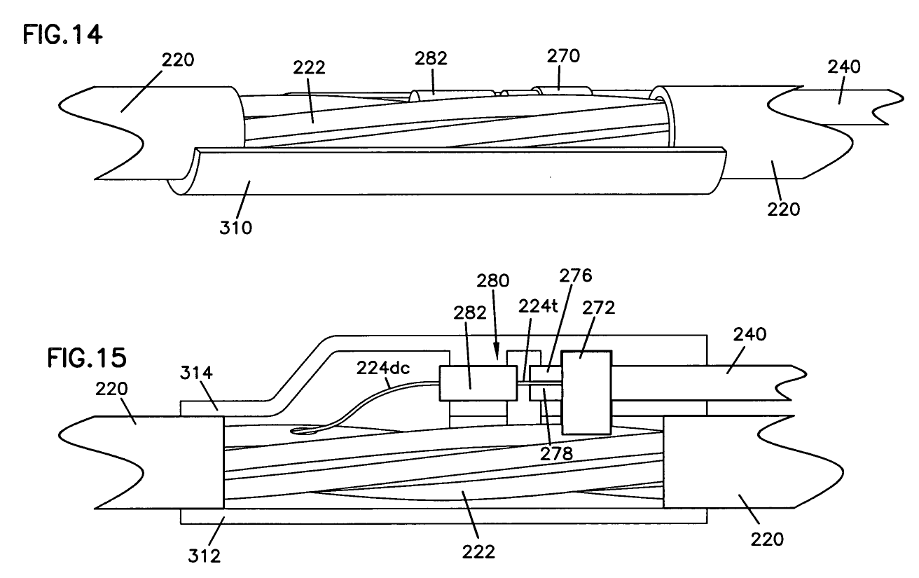

A through passage 315 extends through two fused shells 350 from the first end 302 to the second end 304 of the shells 350. The through passage 315 has a first portion 301 adjacent the first end 302 of the shells 350 and a second portion 303 adjacent the second end 304. The first and second portions 301, 303 of the through passage 315 are sized to accommodate a distribution cable 220 (e.g., see FIG. 15). The first portion 301 of the through passage 315 generally aligns with the second portion 303 to enable the buffer tubes 222 of a distribution cable 220 to extend through the body 310 without obstruction (e.g., see FIGS. 14-15). The outer strength member 228 of the distribution cable 220 can also extend through the through passage 315. In certain embodiments, the first and second portions 301, 303 have a generally U-shaped transverse cross-section (e.g., see FIGS. 12 and 13).

The body 310 also includes a sleeve support 316 and a retention block support 320. The sleeve support 316 defines a first groove 317 sized to accommodate a sleeve, such as sleeve 282 of FIG. 2. The retention block support 320 includes a first end 322 and a second end 324. The first end 322 of the retention block support 320 defines a groove 323 and the second end 324 defines a groove 325. The retention block support 320 also defines a pocket 326 intermediate the grooves 323, 325.

The pocket 326 of the retention block support 320 is sized to accommodate a retention block 270 (e.g., see FIG. 15). In certain embodiments, the pocket 326 is configured to position the retention block 270 to enable the retention block 270 to couple to the outer strength member 228 (e.g., the aramid fiber/yarn) extending through the body 310. The groove 325 on the second end 324 of the retention block support 320 is sized to accommodate a tether 240 including the outer jacket 250 (e.g., see FIG. 15). The groove 325 is positioned to enable the tether fiber 224ₜ, buffer tube 242, and strength members 246 to attach between the cover 272 and the base 274 of the retention block 270 mounted in the pocket 326.

The groove 323 on the first end 322 of the retention block support 320 is sized to accommodate the first and second protrusions 276, 278 extending from the retention block 270. The groove 317 of the sleeve support 316 is substantially aligned with the groove 323 (e.g., see FIG. 10). Such a configuration enables the tether fiber 224ₜ to extend from the retention block 270, through the protrusions 276, 278, to a coupling location 280 (e.g., see FIG. 15).

At least one distribution fiber 224_{dc} extends from one of the distribution cable buffer tubes 222 to the coupling location 280. In general, the second side edge 314 of the body 310 extends outwardly from the first side edge 312 to provide sufficient interior space to enable the at least one fiber 224_{dc} to extend to the coupling location 280 at the sleeve support 316 (e.g., see FIG. 15) without obstruction. In certain embodiments, the second side edge 314 provides sufficient interior space to enable the enclosure 300 to bend without significant interaction with the distribution cable fiber 224_{dc}. The sleeve 282 protecting the fibers 224ₜ, 224_{dc} at the coupling location 280 fits in the groove 317 of the sleeve support 316 of the body 310 (e.g., see FIG. 15).

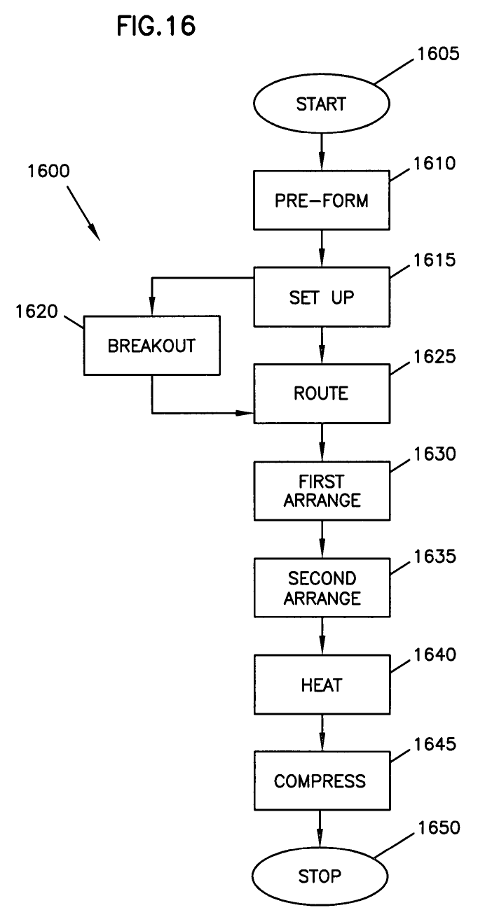

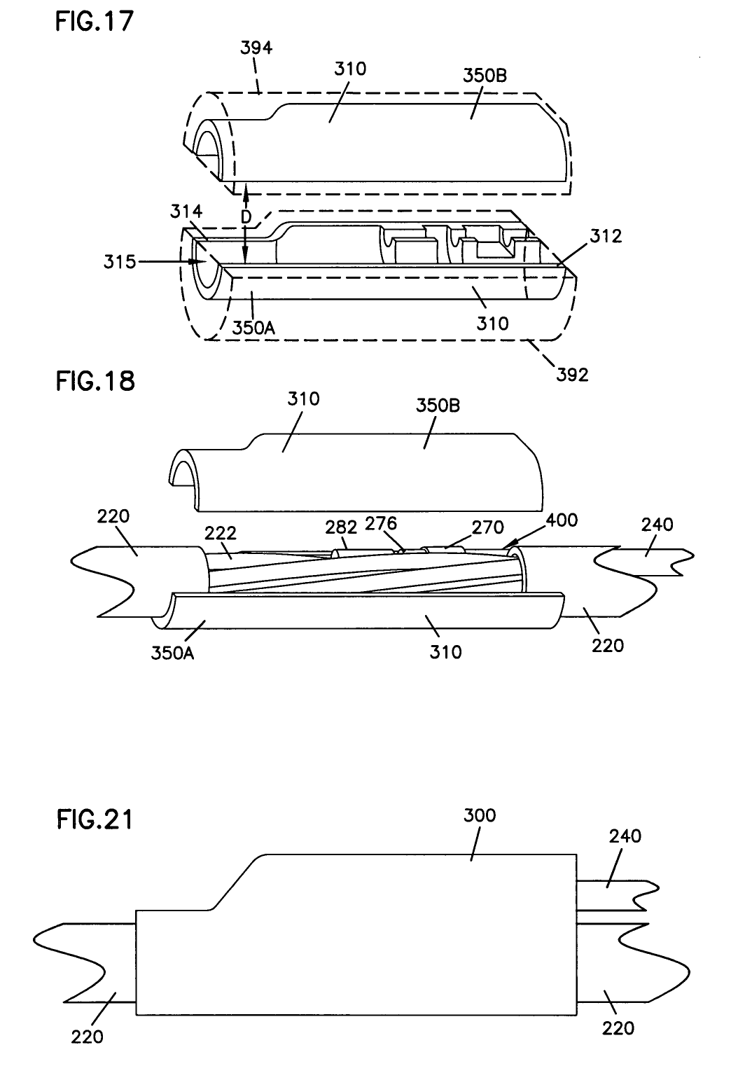

FIG. 16 illustrates an operation flow for an example process 1600 by which the enclosure 300 can be secured to the distribution cable 220 at the breakout location 260. The process 1600 begins at a start module 1605 and proceeds to a pre-form operation 1610. At the pre-form operation 1610, a first shell is formed from a polymeric material, such as polyurethane, at a location remote from the breakout location (e.g., see FIG. 17). A second shell is also formed from the polymeric material during the pre-form operation 1610. In certain embodiments, the shells are formed via injection molding.

Next, in a setup operation 1615, the pre-formed first shell is mounted onto a first mold and the pre-formed second shell is mounted onto a second mold. In certain embodiments, the shells are vacuum suctioned to the molds. The molds are arranged such that the side edges of the shells oppose each other. In other embodiments, the molds are the same molds used to form the shells.

FIG. 17 illustrates the results of the pre-form operation 1610 and the setup operation 1615. In FIG. 17, a first half shell 350A is mounted to a first mold 392 and a second half shell 350B is mounted to a second mold 394. The half shells 350A, 350B are generally mirror images of one another. The molds 392, 394 are arranged such that side edges 312, 314 of the half shells 350A, 350B oppose each other at a distance D so that the grooves 317 of each half shell 350A, 350B align.

Continuing with process 1600, a tether is optically coupled (e.g., spliced) to a distribution cable in a breakout operation 1620. In some embodiments, the tether and the distribution cable are prepared as described above with respect to FIGS. 6-8. A sleeve is mounted over the tether fiber prior to coupling the tether and distribution cable fibers and slid over the optical coupling location after the fibers have been coupled. The retention block, which is affixed to the tether, is mounted to the outer strength members of the distribution cable at the stripped region of the distribution cable.

In a route operation 1625, the first shell is positioned at a stripped region of a distribution cable. In general, the exposed buffer tubes are laid in the portion of the through passage extending through the first shell. Next, in a first arrange operation 1630 the retention block is mounted within a pocket of a retention block support of the first shell. The sleeve protecting the coupled optical fibers is mounted to a sleeve support of the shell in a second arrange operation 1635. In certain embodiments, the first and second arrange operations 1630, 1635 are performed at substantially the same time. In other embodiments, the second arrange operation 1635 can be performed before the first arrange operation 1630.

FIG. 18 illustrates the first half shell 350A secured at a stripped region 400 of a distribution cable 220. The portion of the through passage 315 extending through the first shell 350A retains the exposed buffer tubes 222 and outer strength member 228 of the distribution cable 220. A retention block 270 is positioned within the pocket 326 of the retention block support 320. The protrusions 276, 278 of the retention block 270 extend into the groove 323 at the first end 322 of the retention block support 320. The sleeve 282 is mounted within the groove 317 of the sleeve support 316.

When the breakout assembly has been arranged within the first shell, the engagement surface of at least the first shell is heated in a heat operation 1640. In certain embodiments, the shells are in sufficient proximity to enable heating of the engagement surfaces of both of the opposing shells. The engagement surface of at least the first shell is typically heated to a temperature ranging from about 400° F. to about 475° F. In a preferred embodiment, the engagement surface is heated to about 430° F.

In some embodiments, the shells can be heated by blowing heated gas over the engagement surfaces. In other embodiments, the shells can be heated through ultrasonic welding or vibrations. In still other embodiments, one or more heating bands can be positioned adjacent the side edges of the shell body in heat operation 1640.

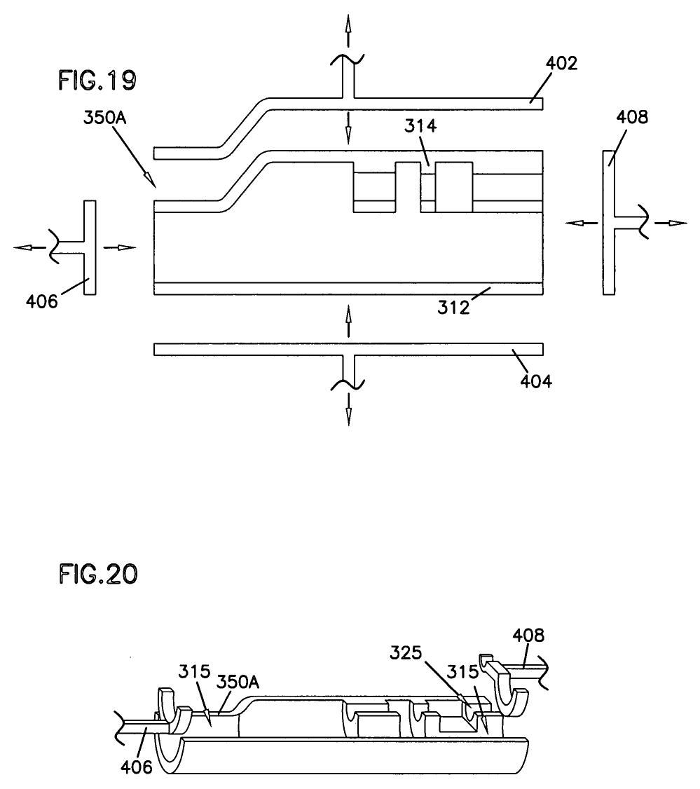

For example, FIGS. 19 and 20 illustrate a heating band assembly 400 configured to heat at least the first enclosure shell 350A. In the example shown, the heating band assembly 400 includes a first element 402 and a second element 404 configured to extend over the side edges 312, 314, respectively, of the shell 350A. As shown schematically in FIG. 19, each heating element 402, 404 of the heating band assembly 400 can move toward and away from the shell 350A sufficient to enable heating and cooling of the shell 350A.

In certain embodiments, the assembly 400 can also include a third element 406 and a fourth element 408 configured to move over and away from the through passages 315, 325 of the shell 350A. Heating the material within the passages 315, 325 can facilitate securing the shell 350A to the cable jackets 230, 250. In the example shown in FIG. 20, the third and fourth elements 406, 408 are shaped to facilitate heating the channels 315, 325 of the first shell 350A. In other embodiments, the third and fourth elements 406, 408 can be shaped to facilitate heating both shells 350A, 350B.

In certain embodiments, the heating elements 402, 404, 406, 408 are coupled to one or more mechanical or electrical actuators (not shown) configured to affect movement of the heating elements 402, 404, 406, 408. The actuator enables the heating elements 402, 404, 406, 408 to slide in between the two opposing shells 350A, 350B. The two shells 350A, 350B can then be pressed together to capture the heating assembly 400. The captured heating elements 402, 404, 406, 408 melt the engagement edges 312, 314 of the shells 350A, 350B. The press molds 392, 394 holding the shells 350A, 350B then separate to enable the heating assembly 400 to slide away from the shells 350A, 350B.

After the heat operation 1640, the press molds are used to compress the heated shells together in a compress operation 1645. The shells are generally aligned so that pressing the shells together causes the melted engagement surfaces to contact one another. Pressure is applied to the shells until the shells have fused together. In certain embodiments, the body of each shell can also fuse with the cable jackets of the distribution cable and tether. For example, in one embodiment, a polyurethane body of each half shell melts and fuses to a polyethylene material forming the outer jackets of the distribution cable and tether.

In certain embodiments of the compress operation 1645, different amounts of pressure are applied to different portions of the shells. For example, in some embodiments of the compress operation 1645, a greater amount of pressure is applied to the outer edges of the shells than to the middle of the shells. In one such embodiment, the molds, such as molds 392, 394 (FIG. 17), holding the shells have raised perimeters adjacent the outer edges of the shells. In other embodiments, the compress operation 1645 applies the same amount of pressure over the body of the enclosure. The process 1600 ends at stop module 1650. Thus, in the example shown in FIG. 21, the half shells 350A, 350B have been fused to form a full enclosure 300.

It is preferred for the enclosure 300 to be sized with a cross sectional shape sufficient to allow the distribution cable at the breakout location 260 to be readily passed through a one and one-half inch inner diameter conduit or a one and one-quarter inch diameter conduit. In certain embodiments, the distribution cable at the breakout location 260 has a cross sectional area that can be passed through a one inch inner diameter conduit.

The breakout location 260 is preferably configured to allow the breakout assembly to be bent/flexed in any orientation without damaging the fibers 224_{dc}, 224ₜ and without significantly negatively affecting cable performance. For example, the fused protective sleeve 300 preferably has sufficient flexibility to allow the pre-terminated cable (i.e., the distribution cable 220 with the tethers terminated 240 thereto) to be readily stored on a spool. In one embodiment, the pre-terminated cable can bend about 180 degrees.

In one embodiment, this flexibility is provided by making sure that the fibers 224_{dc}, 224ₜ have sufficient excess fiber length (i.e., slack) to allow the distribution cable 220 at the breakout location 260 to be bent/flexed the requisite amount. In one embodiment, the fibers 224_{dc}, 224ₜ that extend along the breakout location 260 are provided with at least 2% excess fiber length. In other embodiments, the fibers 224_{dc}, 224ₜ are provided with at least 3% excess fiber length. In still other embodiments, the fibers 224_{dc}, 224ₜ are provided with an excess fiber length in the range of 1 to 5% or in the range of 2 to 5%. In one example embodiment, the length of the breakout location 260 is about 32 centimeters and about 1 centimeter of excess fiber length is provided to the fibers 224_{dc}, 224ₜ as they extend along the breakout location 260.

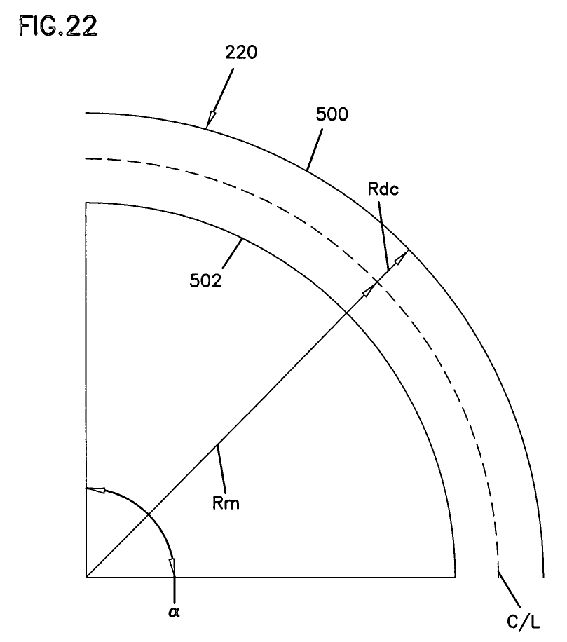

In determining the amount of excess fiber length to be provided at the breakout location 260, it is desirable for the distribution cable 220 to be able to be bent in a minimum bend radius Rₘ in any orientation without compromising the breakout assembly 200. In one embodiment, an example minimum bend radius Rₘ is ten times the outer diameter of the distribution cable 220. When the distribution cable is flexed to a bend having a radius Rₘ as shown at FIG. 22, a portion 500 of the distribution cable 220 at the outside of the curve elongates and a portion 502 of the distribution cable at the inside of the curve shortens. The centerline C/L of the distribution cable does not change in length. Taking the above factors into consideration, the amount of slack fiber length required to accommodate the elongation at the outer portion 500 of the bend can be calculated by the following formula:

$$α \frac{π}{180 °} ( {R}_{m} + {R}_{dc} ) - α \frac{π}{180 °} {R}_{m} = α \frac{π}{180 °} {R}_{dc}$$

In the above formula, where R_{dc} equals the outer radius of the distribution cable measured from the centerline to the outer surface of the outer jacket. R_{dc} provides a value that is representative of the distance between the fibers 224_{dc}, 224ₜ and the centerline of the distribution cable. The angle of the bend is represented in a in degrees. For a 90° bend, the excess fiber length equals at least πR_{dc}/2. For a 180° bend, the excess fiber length equals πR_{dc}.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for protecting a breakout assembly at a breakout location of a distribution cable, the method comprising:
forming at a location remote from the breakout location a first flexible shell from a polyurethane material, the first flexible shell including at least one engagement surface;
forming a second flexible shell from a polyurethane material at the remote location, the second flexible shell including at least one engagement surface;
arranging the first flexible shell opposite the second flexible shells on opposing press-molds;
arranging the distribution cable and the breakout assembly within the first flexible shell;
melting the engagement surface of at least one of the first flexible shell and the second flexible shell;
pressing the first and second flexible shells together to place the engagement surface of the first flexible shell in contact with the engagement surface of the second flexible shell; and
fusing the first flexible shell to the second flexible shell around the distribution cable and the breakout assembly to form a fused enclosure, wherein the distribution cable protrudes from opposite ends of the fused enclosure.

2. The method of claim 1, wherein forming the fused enclosure includes forming a through passage extending through the fused enclosure, the through passage being sized and configured to receive a stripped region of the distribution cable.

3. The method of claim 2, wherein arranging the distribution cable and the breakout assembly includes arranging a stripped region of the distribution cable in a portion of at least one of the first flexible shell partially defining the through passage.

4. The method of claim 1, wherein at least one of forming the first flexible shell and forming the second flexible shell includes forming a retention block support and a sleeve support.

5. The method of claim 4, wherein arranging the distribution cable and the breakout assembly includes arranging a retention block in the retention block support and arranging a sleeve in the sleeve support.

6. The method of claim 1, wherein melting the engagement surface include sliding a heating band assembly over the at least one engagement surface of the at least one flexible shell.

7. The method of claim 6, wherein sliding a heating band assembly over the at least one engagement surface of the at least one flexible shell includes heating the at least one engagement surface to about 430° F.

8. The method of claim 1, wherein melting the engagement surface includes ultrasonically welding the first flexible shell to the second flexible shell.

9. The method of claim 1, wherein pressing the first and second flexible shells together includes applying a first amount of pressure to a first potion of the first and second flexible shells and applying a second amount of pressure to a second portion of the first and second flexible shells.

10. The method of claim 1, wherein the first and second flexible shells each have a durometer ranging from about 75 shore A to about 95 shore A.

11. A telecommunications cable comprising:
a distribution cable including a cable jacket and at least a first buffer tube positioned within the cable jacket, the distribution cable including a breakout location where a portion of the cable jacket has been removed and where the first buffer tube includes a fiber access location;
a tether that branches from the distribution cable at the breakout location, the tether including a tether jacket, a tether buffer tube positioned within the jacket and at least one strength member;
a first optical fiber that extends through the at least one buffer tube of the distribution cable, the first optical fiber being routed out of the first buffer tube;
a second optical fiber that extends through the tether buffer tube, the second optical fiber being optically coupled to the first optical fiber at an optical coupling location to form a fused length of optical fiber;
a first flexible shell having a body mounted on the distribution cable at the breakout location, the body being formed from polyurethane and having a durometer ranging from about 75 shore A to about 95 shore A;
a second flexible shell having a body formed from polyurethane and having a durometer ranging from about 75 shore A to about 95 shore A, the body of the second flexible shell being configured to engage and fuse to the body of the first flexible shell; and
the first and second flexible shells being configured to cooperate to accommodate the distribution cable and the tether at the breakout location when fused together.

12. The telecommunications cable of claim 11, further comprising a tether retention block coupled to the distribution cable and being arranged within the body of the first flexible shell, the tether buffer tube passing through the retention block and at least the strength member of the tether being affixed to the retention block.

13. The telecommunications cable of claim 12, wherein the tether retention block is fully contained within the fused first and second flexible shells.

14. The telecommunications cable of claim 12, wherein at least one of the first and second flexible shells includes a retention block support configured to receive and retain the tether retention block.

15. The telecommunications cable of claim 14, wherein the retention block support includes a pocket and a groove, the pocket configured to accommodate the tether retention block and the groove sized to accommodate protrusions extending from the tether retention block.

16. The telecommunications cable of claim 11, wherein the first and second flexible shells have a durometer of about 85 shore A.

17. The telecommunications cable of claim 11, further comprising a sleeve configured to fit over the fused length of optical fiber at the optical coupling location.

18. The telecommunications cable of claim 17, wherein at least the first flexible shell includes a sleeve support configured to receive and retain the sleeve.

19. The telecommunications cable of claim 11, wherein the distribution cable includes a plurality of buffer tubes.

20. A telecommunications cable comprising:
a distribution cable including a cable jacket and at least a first buffer tube positioned within the cable jacket, the distribution cable including a breakout location where a portion of the cable jacket has been removed and where the first buffer tube includes a fiber access location;
a tether that branches from the distribution cable at the breakout location, the tether including a tether jacket, a tether buffer tube positioned within the jacket and at least one strength member;
a length of optical fiber that optically couples the distribution cable to the tether;
a first flexible shell including a body mounted on the distribution cable at the breakout location, the body having a durometer ranging from about 80 to about 95 shore A;
a second flexible shell including a body having a durometer ranging from about 80 to about 95 shore A, the body of the second flexible shell being configured to engage and fuse to the body of the first flexible shell; and
the first and second flexible shells being configured to fuse together to surround the distribution cable and the tether at the breakout location.
